(19) United States
(12) Patent Application Publication
(10) Pub. No.: US 2008/0031459 A1
(43) Pub. Date: Feb. 7, 2008

(54) Systems and Methods for Identity-Based Secure Communications

(76) Inventors: Seth Voltz, Natick, MA (US); Jesse D. Hurley, Natick, MA (US)

Correspondence Address: Brian M. Dingman;Mirick O'Connell DeMallie & Lougee LLP, 1700 West Park Drive, Westborough, MA, 01581, US

(21) Appl. No.: 11/834,121

(22) Filed: Aug. 6, 2007

Related U.S. Application Data
(60) Provisional application No. 60/821,611, filed on Aug. 7, 2006.

(51) Int. Cl. H04L 9/08; H04L 9/30

(52) U.S. Cl. 380/279; 380/277; 380/30

(57) ABSTRACT

Methods and systems for securing communications between networked computer agents in a positively identifiable manner, using a centralized arbitration computer agent that acts as a trusted third party to store and manage user agent identities. Each user agent has a unique identity, which may be represented by at least a unique key identifier and an associated key. The computer agents use the key identifiers to retrieve the associated keys prior to exchanging messages, and the retrieved keys are used to encrypt the messages. The centralized arbitration agent serves as a key manager and repository by creating and storing the key identifiers, and by storing the associated keys. The centralized arbitration agent also records transactions and state changes for the keys, and handles key expiration, revocation and replacement. The centralized arbitration agent performs similar functions for key signatures.

### CROSS REFERENCE TO RELATED APPLICATION

This application is based upon and claims the benefit of priority from U.S. provisional application No. 60/821,611 filed Aug. 7, 2006, the entire contents of which are incorporated by reference herein.

### FIELD OF THE INVENTION

This invention relates generally to the field of communications. More specifically, this invention relates to systems and methods for securing communications between networked computer user agents in a positively identifiable manner, using a centralized arbitration computer agent that manages user agent identities and acts as a trusted third party.

### BACKGROUND OF THE INVENTION

Attempts to secure communications between two agents, whether human or machine, may be made by various methods, including authentication, authorization, and cryptography.

Authentication is the process of verifying an agent's identity, such as by requiring an agent to provide a user name and password to access a computer or network. The disadvantage of this simple scheme, however, is one of plausible deniability, because the identity of the agent cannot be verified with complete certainty. A higher level of confidence in the agent's identity may be accomplished with strong authentication, a layered authentication approach in which two or more authentication requirements are required to establish the identity of an agent. For example, an agent may be required to provide a user name, password, and an authentication token in the form of a smartcard or biometric trait.

Authorization is the process of determining whether a known agent may use a service, what resources the agent is allowed to access, and the type of access allowed for each. For example, an access control list may be used with a file system to manage read, write, and execute permissions.

In cryptography, an algorithm or cipher uses a key to transform plaintext into ciphertext (encryption) and transform ciphertext back again into plaintext (decryption). Ciphers may be categorized in several ways. For example, some ciphers operate on blocks of data (block ciphers), while others operate on a continuous stream of data (stream cipher). Ciphers may also be characterized by whether the same key is used for both encryption and decryption (symmetric key algorithms), or whether two different keys are used, a first key for encryption and a second key for decryption (asymmetric key algorithms).

In symmetric or private key algorithms, such as DES (Data Encryption Standard), 3DES (Three DES or Triple DES), RC4 (Rivest Cipher #4), IDEA (International Data Encryption Algorithm), and AES (Advanced Encryption Standard), the shared key used by the sending and the receiving agents must be determined in advance of any communication between the agents. Although having one key may simplify communications, it is difficult to simultaneously share and protect the key.

An asymmetric or public key algorithm, such as RSA (Rivest, Shamir, Adelman) or ECC (Elliptical Curve Cryptography), creates two keys that are mathematically related, a public key and a private key. The public key is published and made available to any sending agent, while the private key is kept secret by the receiving agent. A message that has been encrypted with a public key can be decrypted only by the associated private key. While the use of two related keys addresses the distribution problem associated with symmetric key systems, there is still the problem of verifying that the public key is authentic and has not been tampered with or substituted. One means for addressing this problem is to use a public-key infrastructure (PKI), in which a Certificate Authority (CA) issues Digital Certificates, which contain the public/private key pairs needed to encrypt and decrypt data. The Certificate Authority certifies the ownership of the key pairs. Even with a PKI, however, there may be problems. For example, Digital Certificates may be forged, or the Certificate Authority may itself have an inadequate security system.

Public keys may also be signed. Key signing is the act of digitally signing a public key and the associated user identification that is attached to the key. The purpose of key signing is to verify that a given user identification and public key belong to the agent that appears to own the key and is represented by the attached user identification. An agent may sign its own public key, or another agent's public key.

Prior art methods of securing communications between agents on a public network include Off-the-Record Messaging, Pretty Good Privacy, Transport Layer Security, and Secure Sockets Layer.

Off-the-Record Messaging (OTR), is used by instant message (IM) clients to secure communications between end users, and provides encryption and authentication features, including the AES symmetric key algorithm. However, because messages are only encrypted with temporary and anonymous per-message keys, two users cannot securely trade keys to guarantee each other's identity. In addition, there is no third party service that may be used to verify the identities of the users. As a result, an instant message session may or may not be secure, and there is no guarantee that a user is who he says he is.

Pretty Good Privacy (PGP) is an encryption and key-sharing protocol for securing email messages, and uses both symmetric and asymmetric key encryption algorithms. The sender uses the public key half of the recipient's key pair to encrypt a symmetric session key. The session key is then used to encrypt the plaintext message. The receiver decrypts the session key using its private key, then decrypts the ciphertext message using the session key. PGP, unlike PKI, stores keys on public servers, and relies on a “web of trust” to verify identities. The public keys are bound to a user name, and may be digitally signed by a third party user to attest to the association between the public key and the user name.

One disadvantage of PGP is that it does not support automatic key discovery. If a first user wants to send an email to a second user, and the sender does not have the recipient's public key, the email will be sent unencrypted.

Transport Layer Security (TLS), and its predecessor, Secure Sockets Layer (SSL), use a handshaking procedure to create a secure communications between a web client and a web server. A client initiates the handshake by requesting a secure connection with an SSL-enabled server. The server returns its digital certificate, which typically contains the server name, the trusted Certificate Authority, and the server's public key. The client then generates the session key for the secure connection, encrypts the session key using the server's public key, and sends the session key to the server. The server can decrypt the session key using its private key. This procedure creates keys that are not shared with third parties. As with OTR, however, the keys are generated at the beginning of the session, and traded before the session is secured. As a result, two users cannot securely trade keys to guarantee each other's identity.

Therefore, there is a need in the art for methods and systems for securing communications between networked computer user agents in a positively identifiable manner, in which the identities of the user agents are verified before the user agents exchange messages. In addition, there is a need in the art for methods and systems that permit both private and public key signing, and support a centralized public key interface.

### SUMMARY OF THE INVENTION

In a preferred embodiment, the present invention provides methods and systems for securing communications between networked computer user agents in a positively identifiable manner, using a centralized arbitration computer agent that acts as a trusted third party to store and manage user agent identities. In general, identities are collections of information that are sufficient to distinguish one user agent from another.

In a preferred embodiment, there are three types of parties that interact within the secure communications system: (1) identity holders; (2) user agents; and (3) a centralized arbitration agent, also know as the Key Repository and Manager. In a preferred embodiment, the user agents and the Key Repository and Manager communicate over a public network, such as the Internet, although user agents and the Key Repository and Manager may communicate over other types of networks, such as a local area network.

### Identity Holders

Identity holders are persons or objects, such as computers or computer applications, each with its own identity profile. In a preferred embodiment, an identity profile includes one or more characteristics. For example, a person's identity profile may include a name, driver's license number, email address, a birth date, or any other personally-identifying information. A computer's identity profile may include its IP (Internet Protocol) address. Each identity holder has a unique set of characteristics, and therefore a unique identity profile, although many identity holders may share one or more individual characteristics.

### User Agents

User agents are the software or hardware representatives of the identity holders. The user agent interacts with the secure communications system on behalf of the identity holder. The user agent and the identity holder may be one and the same, such as where the identity holder, and the user agent, is a computer, or they may be two different entities, such as where the identity holder is a software application and the user agent is a server computer. Note that a user agent is not bound to an identity holder, and a user agent may represent multiple identity holders at different times. In addition, in alternate embodiments, a user agent may represent multiple identity holders simultaneously.

In a preferred embodiment, each user agent is associated with at least a public key identifier, which in turn is uniquely associated with a public key in a public/private key pair. A user agent is preferably a software application with access to a local database that stores at least public key identifiers and associated public keys for other user agents. This local database is termed a local key ring. The local database or local key ring may also store public key signatures.

### Centralized Arbitration Agent/Key Repository and Manager

The centralized arbitration agent, also called the Key Repository and Manager, tracks all the keys used by each user agent. Specifically, the Key Repository and Manager stores at least one public key identifier and at least one public/private key pair for each user agent. The Key Repository and Manager enables the secure communications between the user agents. The Key Repository and Manager may also transmit the public key identifiers and public keys to authorized user agents, or expire or revoke the public key identifiers and public keys. In addition, the Key Repository and Manager may store public key signatures, and send public key signatures to authorized user agents.

In a preferred embodiment, the Key Repository and Manager is a software application with access to a global database. The global database is termed a global key ring. In a preferred embodiment, the global database is separate and distinct from the local database used by the user agents. The Key Repository and Manager may also have a second, separate database for recording transactions or state changes involving public key and public key signatures, such as one user agent's request and receipt of another user agent's public key, or one user agent's receipt of a public key signature.

### Agent-Agent Communication

A base secure communications system of a preferred embodiment of the invention includes two user agents, Agent A and Agent B, and a Key Repository and Manager. To initiate a communication with Agent B, Agent A transmits its public key identifier to Agent B, and Agent B responds by sending its public key identifier to Agent A. Agent A checks its local key rings, which contains the public key identifiers and associated public keys of all agents that have previously communicated with Agent A, for Agent B's public key identifier. Agent B performs a similar check on its local key ring for Agent A's public key identifier.

If Agent B's public key identifier is found on Agent A's local key ring, Agent A uses the associated public key to communicate with Agent B. Similarly, if Agent A's public key identifier is found on Agent B's local key ring, Agent B uses the associated public key to communicate with Agent A.

If a user agent receives a public key identifier from another user agent, but does not have the other user agent's public key identifier on its local key ring, the receiving user agent sends the other user agent's public key identifier to the Key Repository and Manager, and requests the other user agent's associated public key. In the preferred embodiment, this request is encrypted using the Key Repository and Manager's public key. The Key Repository and Manager will search its global key ring and send the other user agent's public key to the requesting user agent.

For example, if Agent A receives Agent B's public key identifier, but Agent A does not have Agent B's public key identifier on its local key ring, Agent A will request Agent B's public key from the Key Repository and Manager. The Key Repository and Manager will then send Agent B's public key to Agent A. In an alternative embodiment, the Key Repository and Manager may direct a user agent to send that user agent's own public key to the requesting agent. For example, the Key Repository and Manager could direct Agent B to have Agent B send its public key to Agent A.

If the Key Repository and Manager does not have the requested public key identifier or public key on the global key ring, an error condition will be returned to the requesting user agent, and preferably logged. This may occur if the global database is missing data, or if the user agent is requesting a public key for a non-existent user agent, which may indicate transmission error or fraud. Such an occurrence may also trigger the system to perform a sanity check or a search of backup versions of the global database.

### Agent Registration

Before user agents can communicate securely with each other, each user agent must register with the Key Repository and Manager to store its public key identifiers and associated public keys in the global key ring. The user agent first generates a public/private key pair on behalf of the identity holder. Alternatively, the user agent may import a previously generated public/private key pair. Note that a user agent may be associated with more than one public/private key pair. User agents maintain copies of their own public and private keys, and their signatures.

The user agent then transmits its own public key to the Key Repository and Manager, using the Key Repository and Manager's own public key to secure the communication between the user agent and the Key Repository and Manager. In a preferred embodiment, the Key Repository and Manager's public key is pre-installed with the software used by the user agents.

Once the communications link between the user agent and the Key Repository and Manager is secure, the user agent transmits additional information to the Key Repository and Manager, such as the identity profile of the identity holder represented by the agent, and additional keys used by the user agent. After the user agent's public key has been received and verified, the Key Repository and Manager creates a public key identifier for the requesting user agent, transmits the public key identifier to the requesting user agent, and stores the requesting user agent's public key identifier and public key in the global key ring. The requesting user agent's public key may then be requested and sent to other user agents to establish secure connections.

### Key Tracking

The Key Repository and Manager performs key tracking functions. For example, whenever one user agent receives a public key of another user agent, the Key Repository and Manager records the transaction or state change of the public key, preferably in a local database. The Key Repository and Manager also maintains a list of every user agent and tracks the contents of each user agent's local key ring. In addition, the Key Repository and Manager monitors which public keys are valid, which public keys have been signed, and by whom, and tracks the permissions associated with each public key and each signature.

### Key Expiration

A public key may have an expiration time and/or date, which may be set when the key is created. Key expiration permits forced key replacement.

The Key Repository and Manager monitors the expiration times and/or dates of each public key in the global key ring. When a public key expires, the Key Repository and Manager flags the public key as invalid, then informs all the user agents that are holding that key of the key's invalidity.

If the user agent holding the expired key is connected to the Key Repository and Manager at the time the invalidity message is sent, the user agent may be permitted to create a new key for the associated identity holder. Alternatively, the user agent may be completely disconnected from the Key Repository and Manager.

If a user agent that is holding the key is not currently connected to the Key Repository and Manager, the invalidity message may be queued for transmission at a later time, when a connection to the user agent is established. In another embodiment, the invalidity message may be flagged for alternative message delivery, such as by email or SMS (Short Message Service) messaging.

### Key Revocation

A public key may be forced invalid by an authorized user agent. The Key Repository and Manager maintains a list of the authorized user agents that are associated with each key. An authorized agent may be the key owner, or a user agent that has been granted revocation permissions.

When a public key is revoked, the Key Repository and Manager flags the public key as revoked, then informs all the user agents that are holding that key of the key's revocation.

If the user agent holding the revoked key is connected to the Key Repository and Manager at the time the revocation message is sent, the user agent may be permitted to create a new key for the associated identity holder. Alternatively, the user agent may be completely disconnected from the Key Repository and Manager.

If a user agent that is holding the key is not currently connected to the Key Repository and Manager, the revocation message may be queued for transmission at a later time, when a connection to the user agent is established. In another embodiment, the revocation message may be flagged for alternative message delivery, such as by email or SMS (Short Message Service) messaging.

### Key Replacement

The Key Repository and Manager permits an identity holder, acting through its user agent, to replace a key. In this process, the requesting user agent requests the revocation of an existing key, and provides a new key to replace the revoked key. After the key has been replaced, the secure connection between the Key Repository and Manager and the user agent is transitioned to using the replacement public key.

### Messaging Network

The Key Repository and Manager performs a variety of functions, including Key Tracking, Key Expiration, Key Revocation, and Key Replacement. Each of these tasks requires the Key Repository and Manager to send keys throughout the communication system, and to locate users on a network. While there are many ways to accomplish these tasks, the preferred method is through the use of a Push-based communications network.

Note also that the Key Repository and Manager is not required to be a stand-alone service provider. The functions described above may be included as a module in a larger system, and the messaging and agent communications abstracted to function with the larger system.

### BRIEF DESCRIPTION OF THE DRAWINGS

Other objects, features and advantages will occur to those skilled in the art from the following description of the preferred embodiments and the accompanying drawings, in which:

FIG. 1 is a flow chart of a preferred method for establishing a secure connection between two user agents in a secure communication system, in accordance with the present invention;

FIG. 2 is a flow chart of a preferred method for establishing a secure connection between a user agent and the centralized arbitration agent, in accordance with the invention of FIG. 1;

FIG. 3 is a flow chart of a preferred method for tracking keys and signatures, and their state changes, in accordance with the invention of FIG. 1;

FIG. 4 is a flow chart of a preferred method for privately signing a key, in accordance with the invention of FIG. 1;

FIG. 5 is a flow chart of a preferred method for publicly signing a key, in accordance with the invention of FIG. 1;

FIG. 6 is a flow chart of a preferred method for handling expired keys, in accordance with the invention of FIG. 1; and

FIG. 7 is a flow chart of a preferred method for handling a revoked key, in accordance with the invention of FIG. 1.

### DESCRIPTION OF PREFERRED EMBODIMENTS

The present invention provides methods and systems for securing communications between networked computer user agents in a positively identifiable manner, in which the identities of the user agents are verified before the user agents exchange messages. The present invention also provides methods and systems for tracking, expiring, revoking, and replacing user agent keys and signatures.

### Establishing a Secure Connection Between Two User Agents

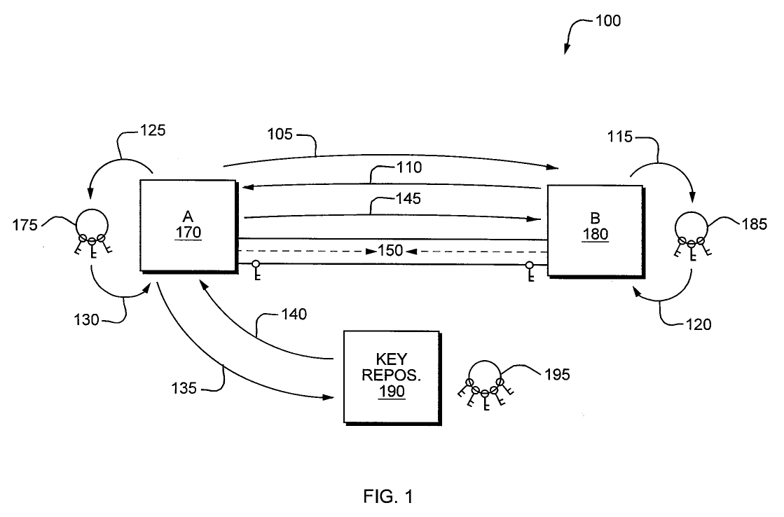

A flow chart of a preferred method for establishing a secure connection between two user agents in Secure Communications System 100 is shown in FIG. 1. In a preferred embodiment, User Agent A 170, User Agent B 180 and Key Repository and Manager 190 are all software applications, each resident on a separate networked computer running a Windows-based operating system, although other operating systems, including variants of the Linux operating system and Mac OS (Apple Inc.'s operating system for Macintosh computers) are contemplated and within the scope of the invention. The present invention is not limited to this configuration, however. For example, User Agent A 170, User Agent B 180 and Key Repository and Manager 190 may all be resident on one computer, or User Agent A 170 and User Agent B 180 may be resident on a first computer, while Key Repository and Manager 190 may be resident on a second computer. Further, the invention is not limited to supporting communications between only two user agents.

Communications between User Agent A 170, User Agent B 180 and Key Repository and Manager 190 may be made via standard network protocols, preferably using TCP (Transmission Control Protocol), although other protocols, including but not limited to UDP (User Datagram Protocol) are contemplated and within the scope of the invention. In a preferred embodiment, each of the computers are connected to a public network such as the Internet, although other public and private networks are contemplated and within the scope of the invention.

As further shown in FIG. 1, User Agent A 170 has a local or personal key ring, 175, and User Agent B 180 has a local or personal key ring 185. In a preferred embodiment, local key rings 175 and 185 are separate databases, each resident on the same computer as its associated user agent, although other configurations are contemplated and within the scope of the invention. In addition, in a preferred embodiment, each local key ring is uniquely associated with its user agent. Key Repository and Manager 190 also has a global key ring 195, which is preferably a database that is separate and distinct from local key rings 175 and 185, and collocated with Key Repository and Manager 190.

With further reference to FIG. 1, User Agent A 170 and User Agent B 180 are each assumed to have previously established a secure connection with the Key Repository and Manager 190. In step 105, User Agent A 170 attempts to connect to User Agent B 180 by passing its identity to User Agent B 180. In a preferred embodiment, User Agent A 170 passes its public key identifier to User Agent B 180. In a preferred embodiment, a public key identifier is a unique hash value that acts as a reference or pointer to the identity profile of the user agent as stored on the Key Repository and Manager 190.

In step 110, User Agent B 180 accepts an initial or preliminary connection with User Agent A 170, and passes its identity to User Agent A 170. In a preferred embodiment, User Agent B 180 passes its public key identifier to User Agent A 170.

In step 115, User Agent B 180 searches its local key ring 185 for User Agent A's 170 public key identifier. User Agent B's local key ring 185 contains at least the public key identifiers and public keys of user agents that have previously established secure connections with User Agent B 180.

In step 120, if User Agent B 180 locates User Agent A's 170 public key identifier in its local key ring 185, User Agent B 180 retrieves User Agent A's 170 associated public key from its local key ring 185 to use in encrypting messages sent to User Agent A 170. In a preferred embodiment, User Agent A's 170 public key is uniquely associated with User Agent A's 170 public key identifier.

In step 125, User Agent A 170 searches its local key ring 175 for User Agent B's 180 public key identifier. User Agent A's local key ring 175 contains at least the public key identifiers and public keys of user agents that have previously established secure connections with User Agent A 170.

In step 130, if User Agent A 170 cannot locate User Agent B's 180 public key identifier in its local key ring 175, User Agent A 170 sends a request to Key Repository and Manager 190 for User Agent B's 180 public key, by passing User Agent B's 180 public key identifier to Key Repository and Manager 190, as shown in step 135.

In step 140, in response, Key Repository and Manager 190 sends User Agent B's 180 public key to User Agent A 170. In step 145, after receiving User Agent B's 180 public key from Key Repository and Manager 190, User Agent A 170 stores User Agent B's 180 public key and public key identifier in its local key ring 175 and notifies User Agent B 180 that it is ready to connect. In a preferred embodiment, User Agent B's 180 public key is uniquely associated with User Agent B's 180 public key identifier.

In step 150, User Agent A 170 and User Agent B 180 establish a secure connection, using the retrieved public keys to encrypt messages sent between them, and their own private keys to decrypt the received messages.

### Establishing a Secure Connection Between a User Agent and the Centralized Arbitration Agent

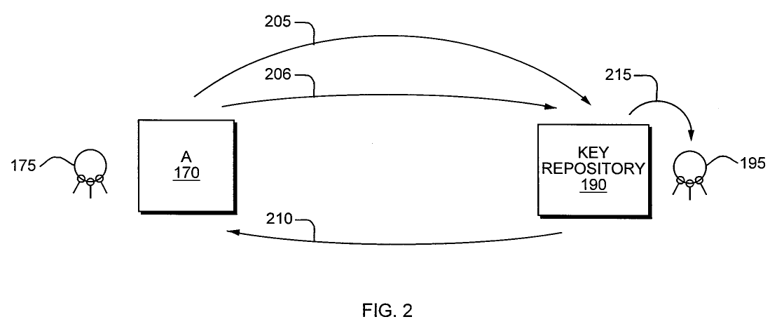

A flow chart of a preferred method for establishing a secure connection between a user agent and the centralized arbitration agent is shown in FIG. 2. In a preferred embodiment, User Agent A 170 generates a public/private key pair of the proper format, and in step 205, transmits its newly created public key to Key Repository and Manager 190. In an alternate embodiment, User Agent A 170 may import a previously generated public/private key pair of the proper format. The proper format for the public/private key pair is determined by a list of accepted key types, such as AES-256 (cipher key with 256 bits). In a preferred embodiment, the list of accepted key types is maintained by the party that manages the Key Repository and Manager 190.

In a preferred embodiment, User Agent A 170 uses Key Repository and Manager's 190 public key, which has been pre-installed, to encrypt User Agent A's 170 public key for transmission to Key Repository and Manager 190. If the Key Repository and Manager's 190 public key has not been pre-installed, the user agent could retrieve it from a known location, such as a specific Internet-connected server that would transmit the public key after establishing an SSL or TLS connection.

In step 206, after User Agent 170 and Key Repository and Manager 190 each have the other's public key, User Agent A 170 transmits additional information associated with its identity profile to Key Repository and Manager 190, using the a secure connection. For example, in a preferred embodiment, User Agent A 170 sends Key Repository and Manager 190 one or more of its other public keys. Key Repository and Manager 190 uses the identity profile information from User Agent A 170 to create a preferably unique public key identifier for User Agent A 170. In step 215, Key Repository and Manager 190 stores User Agent A's 170 public key and associated public key identifier in Key Repository and Manager global key ring 195.

### Key and Signature Tracking

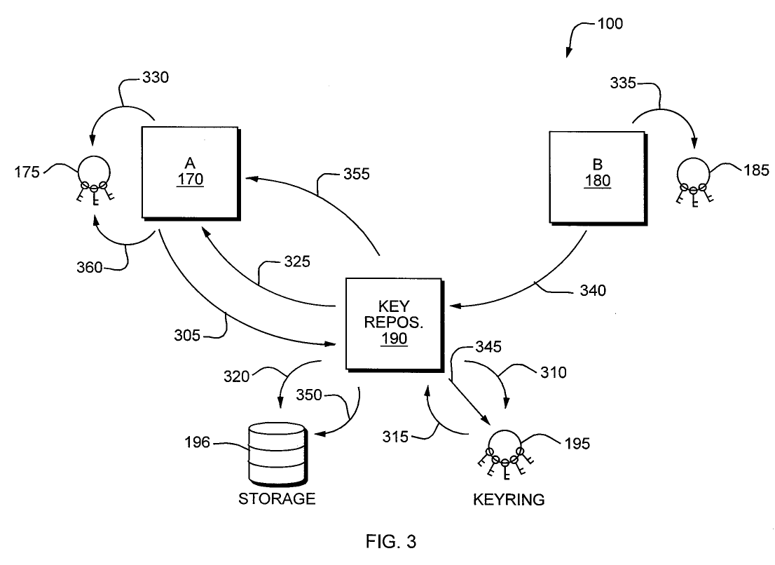

Key Repository and Manager 190 tracks all key and signature state changes that occur within Secure Communications System 100, and maintains a record of the keys and signatures held by each user agent in each user agent's local key ring. A flow chart of a preferred method for tracking key and signature state changes and maintaining a record of the key and signatures held by each user agent is shown in FIG. 3.

In a preferred embodiment, in step 305, User Agent A 170 requests the public key for User Agent B 180 from Key Repository and Manager 190, by passing User Agent B's 180 public key identifier. In step 310, Key Repository and Manager 190 searches its global key ring 195 for User Agent B's 180 public key, and in step 315, retrieves User Agent B's 180 public key from its global key ring 195.

In step 320, Key Repository and Manager 190 records User Agent A's 170 request for User Agent B's 180 public key as a state change in storage 196. In a preferred embodiment, storage 196 is a separate database from the global key ring database 195, but collocated on the same computer as Key Repository and Manager 190. In step 325, Key Repository and Manager 190 sends User Agent B's 180 public key to User Agent A 170. Key Repository and Manager 190 may also update storage 196 to record User Agent A's 170 receipt of User Agent B's 180 public key. In step 330, User Agent A 170 stores User Agent B's 180 public key in its local key ring 175.

In step 335, User Agent B 180 signs User Agent A's 170 public key and stores the signature in its local key ring 185, and in step 340, User Agent B 180 transmits this signature to Key Repository and Manager 190. Note that key signing is typically a user agent-triggered action.

In step 345, Key Repository and Manager 190 stores this signature from User Agent B 180 in its global key ring 195, and in step 350, Key Repository and Manager 190 stores the signature state change in storage 196. Key Repository and Manager 190 may also update storage 196 to record the fact that User Agent B 180 has User Agent B's 180 signature for User Agent A's 170 public key in User Agent B's 180 local key ring.

Key Repository and Manager 190 then determines if any other user agents have permission to see User Agent B's 180 signature, and if so, sends User Agent B's 180 signature of User Agent A's 170 public key to each of those user agents. For example, in step 355, Key Repository and Manager 190, having determined that User Agent A 170 has permission to see User Agent B's 180 signature of User Agent A's 170 public key, sends User Agent B's 180 signature of User Agent A's 170 public key to User Agent A 170. Each user agent that receives the signature saves the received signature to their respective local key ring. For example, in step 360, User Agent A 170 saves User Agent B's 180 signature of User Agent A's 170 public key in its local key ring 175.

### Key Signing

In a preferred embodiment, Secure Communications System 100 provides two methods for signing a key: private key signing and public key signing. In private key signing, the signatures are only visible to a select set of user agents, as specified by the signing agent. In addition, the user agent whose key was signed may specify other user agents that may see the signature. With public key signing, the public signatures are visible to any user agent that can see the key.

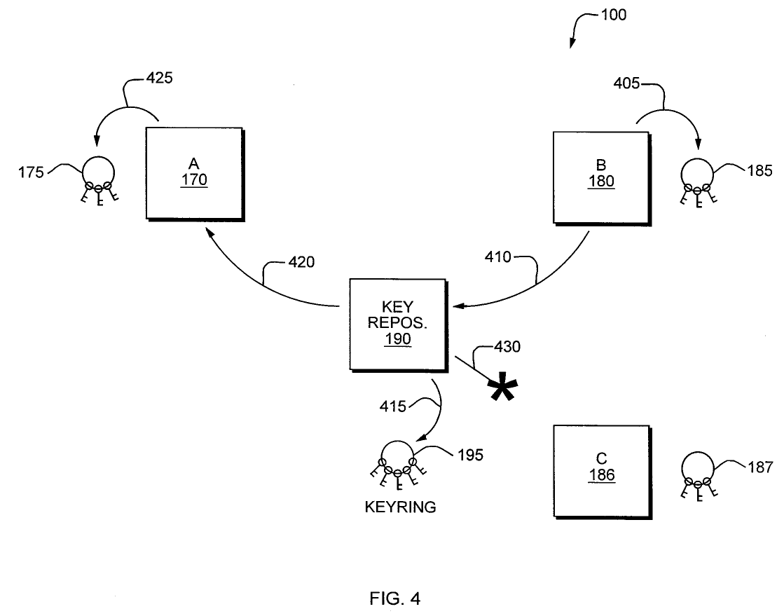

A flow chart of a preferred method for privately signing a key is shown in FIG. 4. In a preferred embodiment, in step 405, User Agent B 180 signs User Agent A's 170 public key and stores the signature in User Agent B's local key ring 185. In step 410, User Agent B 180 sends the signature to Key Repository and Manager 190, along with a list of user agents that are permitted to see the signature.

In step 415, Key Repository and Manager 190 saves the signature to its global key ring 195, and in step 420, using the Key Tracking methods described previously, Key Repository and Manager 190 sends the signature to User Agent A 170 and to all other user agents that have permission to see the signature. In step 425, User Agent A 170 saves the signature to its own local key ring 175.

In this example, User Agent C 186 does not have permission to see the signature. As shown by the uncompleted step 430, then, Key Repository and Manager 190 does not send the signature to User Agent C 186.

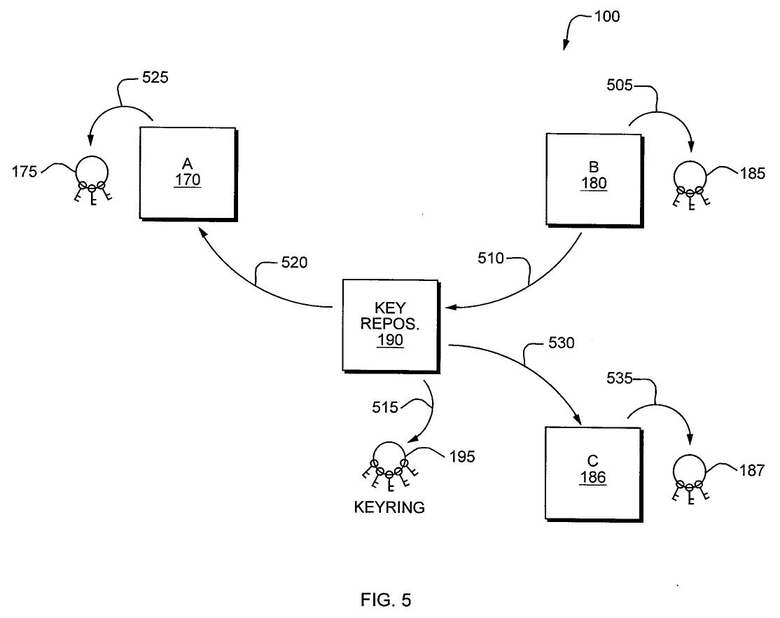

A flow chart of a preferred method for publicly signing a key is shown in FIG. 5. In a preferred embodiment, in step 505, User Agent B 180 signs User Agent A's 170 public key and stores the signature in User Agent B's local key ring 185. In step 510, User Agent B 180 sends the signature to Key Repository and Manager 190. In step 515, Key Repository and Manager 190 saves the signature to its global key ring 195.

In step 520, Key Repository and Manager 190 sends the signature to User Agent A 170, and in step 525, User Agent A 170 saves the signature to its own local key ring 175. In step 530, using the Key Tracking methods described previously, Key Repository and Manager 190 sends the signature to all user agents that have User Agent A's 170 key. Each recipient user agent stores the signature to its own local key ring. For example, in step 535, User Agent C 186 stores the signature in its local key ring 187.

### Key and Signature Expiration

A key may have an expiration time and/or date, which may be set when the key is created. An expired key may be used as a system safety measure, or as a means to implement temporary keys. In a preferred embodiment, Key Repository and Manager 190 stores the key's expiration time and/or date, and sets a timer to go off when the key expires.

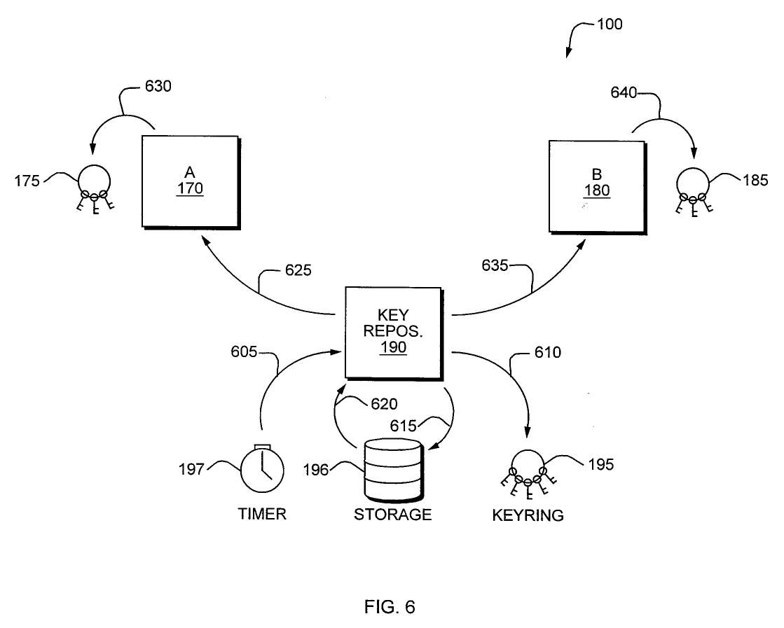

A flow chart of a preferred method for handling an expired key is shown in FIG. 6. In a preferred embodiment, in step 605, the timer 197 associated with User Agent A's 170 key expires, and notifies Key Repository and Manager 190. In step 610, Key Repository and Manager 190 invalidates the key that is stored in its global key ring 195. In a preferred embodiment, Key Repository and Manager 190 invalidates a key by setting a flag in the key's record.

In step 615, Key Repository and Manager 190 records the key state change in storage 196, and in step 620, retrieves a list of all user agents that are holding User Agent A's 170 key. In step 625, Key Repository and Manager 190 notifies User Agent A 170 that its key has expired.

In step 630, upon receipt of the invalidity notification from Key Repository and Manager 190, User Agent A 170 invalidates its key that is stored in its local key ring 175. If User Agent A 170 chooses to create a new key, it must follow the procedures described above for generating a key and transmitting the key to Key Repository and Manager 190.

In step 635, Key Repository and Manager 190 sends an invalidity notification to all user agents that are holding User Agent A's 170 key. Each user agent then invalidates the key in its own local key ring. For example, in step 640, User Agent B 180 invalidates the key in its local key ring 185.

If a user agent is connected to the Secure Communications System 100 when its key is invalidated, its connections to other user agents, and to Key Repository and Manager 190 are terminated. The disconnected user agent must then generate a new key and reestablish connections, or use a different, non-invalid key to reestablish connections.

A key signature may also have an expiration time and/or date. The preferred method for handling an expired signature is the same as described above for handling an expired key.

### Key and Signature Revocation

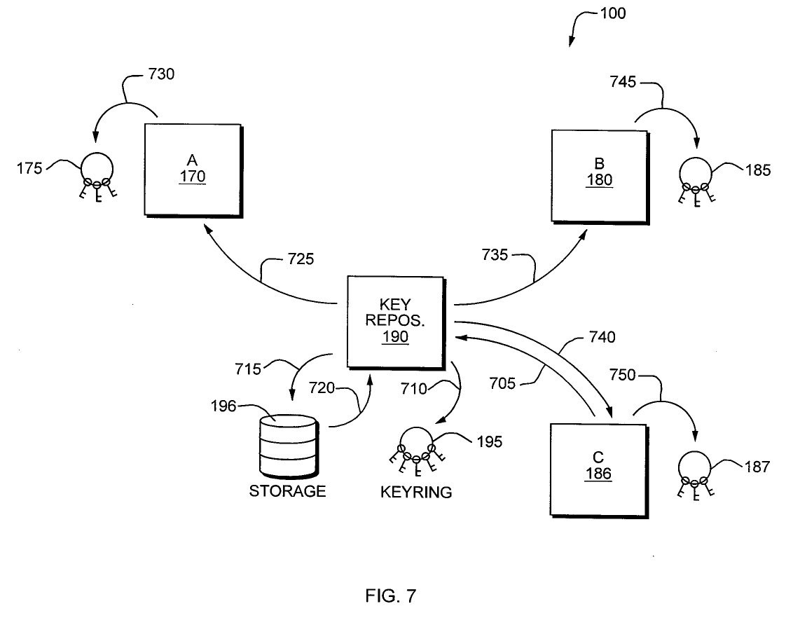

Keys may be revoked by the key's owner or by an authorized user agent. A flow chart of a preferred method for revoking a key is shown in FIG. 7. In a preferred embodiment, in step 705, User Agent C 186, which has permission to revoke User Agent A's 170 key, does so by notifying Key Repository and Manager 190.

In step 710, Key Repository and Manager 190 invalidates the key in its global key ring 195. In step 715, Key Repository and Manager 190 records the key state change in its storage 196, and in step 720, retrieves a list of all user agents that hold User Agent A's 170 key from storage 196.

In step 725, Key Repository and Manager 190 notifies User Agent A 170 that its key is no longer valid, and in step 730, User Agent A 170 invalidates the key in its own local key ring 175.

Key Repository and Manager 190 sends an invalidity notification to all user agents that are holding User Agent A's 170 key. For example, in step 735, Key Repository and Manager 190 notifies User Agent B 180, and in step 740, Key Repository and Manager 190 notifies User Agent C 186. Upon receipt of the invalidity notification, the user agents invalidate the key in their own local key rings. For example, in step 745, User Agent B 180 invalidates the key in its key ring 185, and in step 750, User Agent C 186 invalidates the key in its key ring 187.

If a user agent is connected to the Secure Communications System 100 when its key is revoked, its connections to other user agents, and to Key Repository and Manager 190 are terminated. The disconnected user agent must then generate a new key and reestablish connections, or use a different, non-invalid key to reestablish connections.

A key signature may also be revoked. The preferred method for handling a revoked signature is the same as described above for handling a revoked key.

### Key Replacement

The Key Repository and Manager 190 permits the original key holder to request that their key be replaced by a new key. The process for replacing is key is similar to the key revocation procedure, described above, except that the initiating user agent is the original key holder.

### Extended Network Usage

In addition to functioning as a separate stand-alone service, Key Repository and Manager 190 can be incorporated as a plug-in module to another system comprising a collection of user agents or peers that are connected to a central server in a network configuration. Key Repository and Manager 190 may be especially beneficial in a system for pushing messages, arbitrated by a control manager, to user agents or peers connected in a network architecture.

Although specific features of the invention are shown in some drawings and not others, this is for convenience only, as the features may be combined in other manners in accordance with the invention. Other embodiments will occur to those skilled in the art and are within the following claims.

What is claimed is:

1. A method for establishing a secure connection between networked computer agents, comprising:
sending a first identifier from a first computer agent to a second computer agent;
retrieving a first key from a second agent database, where the first key is associated with the first identifier;
sending a second identifier from the second computer agent to the first computer agent;
retrieving a second key from a first agent database, where the second key is associated with the second identifier; and
sending at least one message from the first computer agent to the second computer agent, where the at least one message is encrypted using the second key.

2. The method of claim 1, where the first identifier is uniquely associated with the first key and the second identifier is uniquely associated with the second key.

3. The method of claim 1, where the first agent database is uniquely associated with the first computer agent and the second agent database is uniquely associated with the second computer agent.

4. The method of claim 1, where the first key and the second key are public keys, and each public key has a corresponding private key.

5. The method of claim 4, where the at least one message is decrypted using the second public key's corresponding private key.

6. The method of claim 1, further comprising:
requesting the first key from a first key management database by sending the first identifier from the second computer agent to a key management computer agent;
retrieving the first key from the first key management database, where the first key is associated with the first identifier; and
sending the first key from the key management computer agent to the second computer agent.

7. The method of claim 6, where the first key management database is uniquely associated with the key management computer agent.

8. The method of claim 6, where the key management computer agent records the request for the first key in a second key management database.

9. The method of claim 6, where the second computer agent receives and stores the first key in the second agent database.

10. The method of claim 6, where the key management computer agent records the sending of the first key to the second computer agent in a second key management database.

11. The method of claim 1, where the first identifier is generated by a key management computer agent and sent to the first computer agent before being sent to the second computer agent and the second identifier is generated by the key management computer agent and sent to the second computer agent before being sent to the first computer agent.

12. A method for distributing a key signature, comprising:
receiving a key signature from a first computer agent at a key management computer agent;
storing the key signature in a first key management database, where the first key management database is uniquely associated with the key management computer agent;
sending the key signature from the key management computer agent to a second computer agent, where the second computer agent is authorized to receive the key signature; and
recording the sending of the key signature to the second computer agent in a second key management database.

13. The method of claim 12, where the second computer agent receives and stores the key signature in a second agent database, and where the second agent database is uniquely associated with the second computer agent.

14. A method for invalidating a key associated with a first computer agent, comprising:
receiving a first invalidity notification for a key;
identifying the key as invalid in a first key management database;
sending a second invalidity notification for the key to a second computer agent, where the key is stored in a second agent database associated with the second computer agent; and
recording the sending of the second invalidity notification in a second key management database.

15. The method of claim 14, where the first invalidity notification is triggered by an expiration of the key.

16. The method of claim 14, where the first invalidity notification is received from the first computer agent.

17. The method of claim 14, where the first invalidity notification is received from a third computer agent.

18. A method for invalidating a key signature associated with a first computer agent, comprising:
receiving a first invalidity notification for a key signature;
identifying the key signature as invalid in a first key management database;
sending a second invalidity notification for the key signature to a second computer agent, where the key signature is stored in a second agent database associated with the second computer agent; and
recording the sending of the second invalidity notification in a second key management database.

19. The method of claim 18, where the first invalidity notification is triggered by an expiration of the key signature.

20. The method of claim 18, where the first invalidity notification is received from the first computer agent.

21. The method of claim 18, where the first invalidity notification is received from a third computer agent.

22. A system for exchanging messages between networked computer agents, comprising:
a first agent database for storing a second public key uniquely associated with a second public key identifier;
a second agent database for storing a first public key uniquely associated with a first public key identifier;
a first computer agent, having computer-executable instructions for sending a first public key identifier to the second computer agent and retrieving the second public key from the first agent database;
a second computer agent, having computer-executable instructions for sending the second public key identifier to the first computer agent and retrieving the first public key from the second agent database;
a first key management database, for storing the first and second public key identifiers and the first and second public keys; and
a key management computer agent, having computer-executable instructions for generating the first and second public key identifiers, storing the first and second public key identifiers in the first key management database, sending the first public key identifier to the first computer agent and the second public key identifier to the second computer agent, and sending the first public key to the second computer agent and the second public key to the first computer agent.
